(19) United States
(12) Patent Application Publication
(10) Pub. No.: US 2013/0326638 A1
(43) Pub. Date: Dec. 5, 2013

(54) Sicherheitssystem

(71) Applicant: Christian ZANDER, Berlin (DE)

(72) Inventor: Christian ZANDER, Berlin (DE)

(73) Assignee: protected-networks.com GmbH, Berlin (DE)

(21) Appl. No.: 13/906,361

(22) Filed: May 31, 2013

(30) Foreign Application Priority Data
May 31, 2012 (DE) 102012209250

(51) Int. Cl. G06F 21/60

(52) U.S. Cl. CPC G06F 21/604
USPC 726/28

(57) ABSTRACT

A method for a setting of security settings in relation for objects is provided. The method comprises the following: storing of access rights identifiers, object identifiers and user identifiers in a data storage, displaying at least each of an object symbol, an access right symbol, and a user symbol in a graphical user interface of a computer, wherein the object symbol relates to an object identifier stored in the data storage, wherein the access rights symbol relates to an access rights identifier stored in the data storage, and wherein the user symbol relates to a user identifier stored in the data storage. Moreover, a selection of an object symbol, a displaying of the selection, a selection of a user symbol and a movement of the user symbol in an environment of the access rights symbol, wherein a security setting to the object is set.

The invention relates to a method for a setting of security settings, a security system and a computer system.

In today's computer systems and networks a plurality of users may access a plurality of resources. A resource may denote, e.g., data in form of files in file systems, but also applications, devices like printers, storage systems, special computers and so on. Typically, not all users are allowed to access all resources. Such a limitation may be required based on data protection, system security and confidentiality reasons or, because of other security aspects. Moreover, there may be a differentiation between different access rights to individual resources. There may be, e.g., users, which may be allowed to view certain information but they may not be allowed to alter the information. The same may apply to certain functions within an application. For example, a user may change information relating to his person like address or date of birth via a web portal, but he may not be allowed to make such changes in respect to his monthly payment or his contractually granted vacation. If an employee may not longer work for en enterprise, his access rights to enterprise resources need to be completely deleted or blocked.

An important task of security administrators is exactly such a rights management or access management. On a continuous basis, he must make resources available and grant rights to users—i.e., application users—control the rights and keep them in line with enterprise guidelines. Typically, the individual objects or resources, person's IDs or rights may be stored in tables.

Moreover, computer processes and programs—or in short, processes—access resources of computer networks. Also for this, access rights management may be required. Consequently, access rights management may mean a significant workload for system administrators and security officers in IT departments and other departments dealing with access rights management.

There are several initiatives, which shall ease the workload for security administrators. For example, EP 2 408 140 A1 discloses a method for a configuration of access rights, a control point, a device and a communication system for configuring access rights. Primarily, this disclosure discloses an exchange of access rights between control points based on lists of access rights.

Therefore, there is a need for an elegant method and a related device allowing system administrators and security officers in IT and other departments responsible for access rights management to perform an access rights management in computer systems and computer networks in a preferably easy, intuitive and time saving manner. The invention is based on the objective to build such a system.

### SUMMARY OF THE INVENTION

This objective is solved by the subject matter of the independent claims. Advantageous embodiments of the disclosed invention are described in the dependent claims.

According to a first aspect of the invention, a method for a setting of security settings relating to objects in a computer network is provided. The method may comprise: storing of access rights identifiers, object identifiers and user identifiers in a data storage, a displaying of at least an object symbol, an access rights symbol and a user symbol on a graphical user interface of a computer, wherein an object—e.g., in the computer network—may be related to an objects which identification may be stored in the data storage, wherein the access rights symbol may be related to an access rights identifier in the data storage, and wherein the user symbol may be related to a stored user identifier in the data storage.

Furthermore, the method may comprise: selecting at least one object symbol using the graphical user interface and visualizing of the selection of the object symbol as well as selecting the user symbol using the graphical user interface and moving the user symbol in an environment of the access rights symbol, wherein in the data storage an access right, which may be defined by the access rights symbol, is set to the object, which may be defined by the object symbol, for the user identifier, which may be defined by the user identifier, such that a security setting to the object in the computer network is set.

According to another aspect of the invention, a storage system for setting security settings in a computer network is disclosed. The security system may comprise: a storage unit adapted for displaying of at least an object symbol, an access rights symbol and a user symbol in a graphical user interface of a computer, wherein the object symbol may be related to an object identifier stored in the data storage, wherein the access rights symbol may be related to an access rights identifier in the data storage, and wherein the user symbol may be related to a user identifier.

Moreover, the security system may comprise: a selection unit adapted for selecting of at least one object symbol that may be related to an object using the graphical user interface, a visualization unit adapted for displaying the selection of the object symbol, as well as a selection unit adapted for selecting a user symbol using the graphical user interface and moving the user symbol in an environment of the access rights symbol, wherein in the data storage an access right, related to the access rights symbol, to the object, related to the object symbol, may be set for the user, which may be related to the user symbol, such that a security setting in the computer network to an object may be set.

It may be noted that the moving may be achieved by using a pointing-device/pointer combination—i.e., a computer mouse and a pointer symbol or pointer in the user interface. Additionally, the phrase “in an environment” may include a movement of the user symbol directly onto the right access symbol. The environment may also be defined by a predefined radius in relation to a symbol, which may be located in the middle of a circle in the user interface. The radius may be set depending on the screen size and/or the symbol size.

### DETAILED DESCRIPTION

The following terms will be used throughout this application:

Security setting—The term “security setting” may, in particular, refer to access rights but also to the access right for a user to define access rights. Security settings may be defined by, or limited by, guidelines or policies, respectively.

Access rights—The term “access rights” denotes options in managing objects. In particular, the right to “read”, “generate”, “change”, “write” and “delete” are focus. But access rights are not limited to these options or functions respectively, but may also include the right to change access rights. Access rights may also be denoted as access mode.

Object—The term “object” may denote any resource in a computer or computer network. More specifically: devices, computers, servers, printers, scanners, storage systems, applications and/or software programs, workflows, files, databases, single entries in databases, tables, user groups, cameras, doors, and so on, or parts of the named resources or partial functions. Finally, each resource that may be addressable in a computer network may be an object. Furthermore, also non-electronically accessible resources—like people or items—may be affected.

User—The term “user” denotes, in particular, real people, groups of people or technical devices adapted for a computer to a computer communication system. In this context, users may be objects that may access objects. E.g., an application program may access a file. In this case, the object “application program” may need an access right to the object “file”.

Identifier—The term “identifier” or ID may by an electronic identification storable electronically. Each user and each object may be assigned a respective identifier by which it may be uniquely identifiable. In general, identifiers may be unique.

Data storage—The term “data storage” may denote any appropriate system for storing of information. It may include databases but also simple files. It may allow storing relationships between information items. Advantageously, the storage may allow grouping of expressions like symbols or identifiers. Instrumental may also be the possibility to enforce uniqueness of certain expressions to achieve that e.g., user identifiers of object identifiers may only be available once.

Select—The term “select” may be understood here as a selection in a graphical user interface. Instrumental may be pointing devices such as a computer mouse with a respective indicator—e.g., a pointer in the graphical user interface. Additionally, it may be possible to perform the selection using a keyboard, a touch sensitive display, speech recognition or gesture recognition.

Visualize—The term “visualize” may relate to an optical visualization of a certain number of elements such as objects, in particular, user symbols, objects symbols or access right symbols in a graphical user interface. Typical technical means are highlighting by another color, blinking, encirclng using a symbol, covering by a transparent symbol, adding another background color, each combination of these features or, by other differentiating features known to a skilled person.

Moving—The term “moving” may mean fixing a displayed symbol or element using a pointer, in particular of a computer mouse, a track ball, gestures and/or speech recognition and a dragging of the element in the graphical user interface. With this, displayed elements may be moved user-defined within the graphical user interface, e.g., also to other symbols or over other symbols or elements such that these may be partially or complete covered.

Pointing device—This term may denote a device for pointing at something. Typically, this may be a computer mouse, a trackball in combination with a mouse pointer in a graphical user interface or, a touch sensitive display, wherein the pointer may be moved using a finger or a pen by touching the surface of the touch sensitive display.

In the following, advantageous embodiments of the subject-matter of the dependent claims are described.

According to one embodiment of the method, at least one of the object symbols, access right symbols and user symbols displayed in the user interface may comprise a label stored in the data storage. With this, an easier guidance of the user and a more precise assignment of the symbols to objects, access rights and users may be possible.

According to a further embodiment of the method, the graphical user interface may be operated using a pointing device—e.g., a computer mouse—or using a touch sensitive display. This way, a state-of-the-art manual record and table oriented data entry for registering of access rights may be avoided. Using this approach, groups of objects access rights and/or users may be managed at the same time by jointly selecting and assigning them. A selection via a function “multiple select” makes the operation of the graphical user interface easier and increases productivity of the administrator.

According to a further embodiment of the method, the selection in the graphical user interface may be achieved via gesture recognition or voice recognition. This implies a new way of interacting with a security system. Not only the selection but also the complete operation of the security system may be performed by the gesture recognition or the voice recognition. If, e.g., a large number of users and/or objects in the computer network have to be managed, a single administrator may interact via gestures with the security system, using a very large display, e.g., of the 30, 40 or 50 inch class, or via several mid-sized displays of, e.g., the 24 inch class. Using a pointing device may no longer be required. The gestures of an administrator may be received and additionally analyzed via a gesture recognition device, e.g., a camera and may be translated in control signals for the graphical user interface, such that a pointing device may be replaceable. A further performance increase of an administrator may be a positive effect. Additionally, it may be noted that the security system may be operated by a mixture of gesture control, voice control and computer mouse or tracking ball.

According to an additional embodiment of the method, the data storage may be a table stored in a file system of a computer. The data storage may be implemented as a database or as a file in a file system. Both variants have their advantages. A file system is relatively easy to manage, whereas a database allows more complex management functions. Entries in the data storage may be made using different formats, e.g., as ACL (access control list), in the XACML format (eXtended Access Control Markup Language) or in any other markup language. As operating system may be used a Microsoft Windows operating system, a Unix derivative, or an operating system for a mobile device, e.g., Android, Symbian, Windows Mobile, or other. This may imply a high flexibility of the method or the security system, respectively. Additionally, the data in the data storage may be stored in an encrypted way. This may enhance the security of the method or the security system, respectively. A decryption before a displaying in the graphical user interface may be another prerequisite.

According to a further advantageously embodiment, the method may also comprise a selecting of an object-access-rights-user-combination—In particular, as described above—and a release of the same by a delete symbol in the graphical user interface. As described elsewhere in this document, the whole combination that may, e.g., be made visible by connection lines or a highlighting of relevant symbols in the graphical user interface, may be deleted by dragging the complete combination onto a delete symbol, which may have the form of a recycle bin or any other delete symbol. The combination may be visualized by connection lines between the high-lighted symbols or symbol groups, respectively. This may also result in productivity gain for the administrator because access rights to objects for single users or user groups may be deleted more simply.

In one embodiment of the method, an access right comprises an access limitation within a time period or, to a process step in a workflow or, to a project status, or to an access location at which the user may be located. Using this option, also complex time-dependent conditional access rights may be managed elegantly. For a service technician, access to a rack or server cabinet may be limited to a certain time frame during which the service technician may perform his service tasks. Outside of this time frame, access may be denied. Such a access right with a time limitation or depend on another condition—here symbolized by a mechanical access right to a door of a server cabinet—implies an expansion of the stored information by the time information—i.e., start and finish time—in the data store. Additionally, for time-wise limited rights other symbols in the graphical user interface may be used. Also for this, there may be related references in the data storage. Also, other labels of the symbols may be provided.

The inventive system may be partially or completely be implemented as a data processing program or computer program, or program element. For this purpose, it may be stored on a computer-readable medium.

In this sense, the usage of such a computer program in this document may be equivalent with the term program element, a computer program product and/or computer-readable medium that may store control signals for controlling a computer system in order to control the behavior of the system or the method, respectively, in order to achieve the results by the inventive method.

The computer program may be implemented as any computer-readable instruction code in a suitable programming language, like e.g., JAVA, C++ and so on. The computer program product may be stored on a computer-readable medium (CD-ROM, DVD, Blu-Ray Disk, exchangeable device, volatile or non-volatile memory, embedded memory/processor and so on). The instruction code may program a computer or any other programmable device like a security system such that the desired functions may be executed. Additionally, the computer program may be available in a network like the Internet, from where it may be downloaded to the user as required.

The invention may be implemented using a computer program, i.e., software, as well as by one or more electronic circuits, i.e., in hardware or, in a hybrid form, i.e., using software components and hardware components.

It should also be noted that embodiments of the invention have been described with reference to different subject-matters. In particular, some embodiments have been described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which the invention is not limited.

### BRIEF DESCRIPTION OF THE DRAWINGS

FIG. 1 shows an example of a block diagram of the disclosed method for a setting of security settings.

FIG. 2 shows an example for a schematic illustration of a graphical user interface.

FIG. 3 shows an example for a selection of objects in the graphical user interface.

FIG. 4 shows an example for assigning of a plurality of user symbols, access rights and objects.

FIG. 5 shows a table for access rights management.

FIG. 6 shows a block diagram of a security system.

FIG. 7 shows a computer system with the security system.

### DESCRIPTION OF EXEMPLARY EMBODIMENTS

It may be noted that features or combinations of components of different embodiments having the same, or at least functional the same features or components respectively, are marked with the same reference numeral or, with different reference numerals differing in the first digit compared to the reference numerals with (functional) equivalent features or a (functional) equivalent component. For avoiding unnecessary repetitions, features described in the context of an earlier described embodiment or component respectively, will not be described in detail again at a later stage.

Additionally, it may be noted that the following described embodiments show only a limited selection of possible embodiments of the invention. In particular, it may be possible to combine features of individual embodiments in a suitable manner such that a skilled person—using the here explicitly shown embodiments—will be able to imagine a plurality of different embodiments as evidently disclosed.

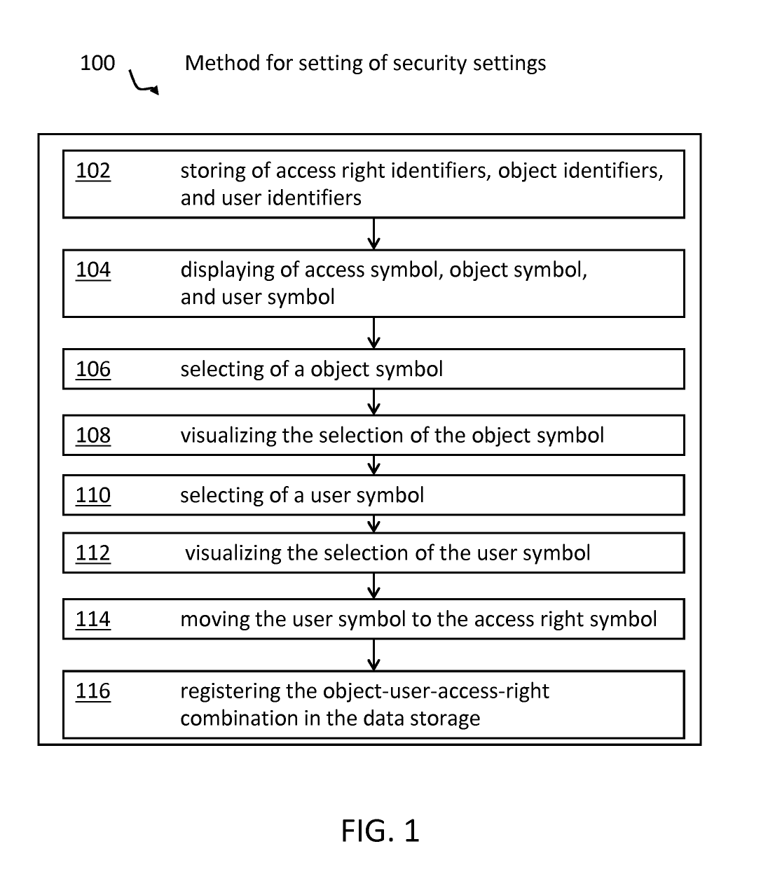

FIG. 1 shows an example of a block diagram 100 of the disclosed method—in particular, changing and deleting—of security settings in respect to objects in a computer network. The method comprises: storing 102 of access rights identifiers, object identifiers and user identifiers in a data storage, in particular, in a file of a file system or, database, as well as displaying 104 of at least each of an object symbol, an access rights symbol and a user symbol in a graphical user interface of a computer. The respective symbols may be different. Symbols of the same class may advantageously be shown as identical or similar symbols. The object symbol refers to an object and its identifier stored in the data storage. The access rights symbol refers to an access rights identifier stored in the data storage and the user symbol refers to a user identifier stored in the data storage. An additional element of the method refers to a selecting 106 of at least one object symbol associated with one of the objects using a graphical user interface. Thereby, a multiple selection of kindred symbols is possible.

Moreover, the method comprises: visualizing 108 the selection of the object symbols and selecting a user symbol—and, if necessary, displaying of the user symbol 112—using the graphical user interface as well as moving 114 the user symbol in an environment of the access rights symbol, wherein in the data storage the access right, represented by the access rights symbol, to the object, defined by the object symbol, for a user identifier, defined by the user symbol, is assigned or set 116, such that a security setting in the computer network to the object is set.

Objects may be all kind of resources in a computer or computer network: in particular, devices, computers, servers, printers, scanners, storage systems, applications or software programs, workflows, files, databases, entries in databases, tables, user groups, cameras, doors, windows, views, parts of data, portals and so on. The same applies to users: user may also be of technical program nature like processes, threads, applications programs or parts thereof.

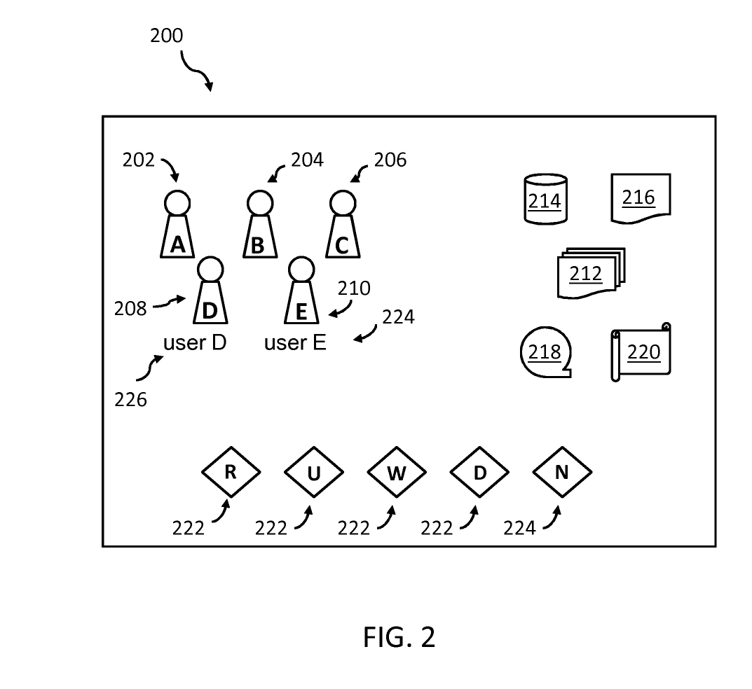

FIG. 2 shows an example of a schematic representation of a graphical user interface for the method. On a screen or in a window of the graphical user interface are shown symbols for user identifiers 202, 204, 206, 208, 210, symbols for objects or object identifiers, respectively 212, 214, 216, 218, 220 and symbols for access rights identifiers 222. The user symbols 202, 204, 206, 208, 210 may comprise labels “A”, “B”, “C”, “D”, “E” or symbol labels 224, 226, here in form of “user A”, user B”.

Additionally, a group of objects 212, 214, 216, 218, 220 or resources in the computer or computer network are shown. Also, these symbols may have optional labels stored in the data storage (not shown here).

The access rights identifiers 222 correspond, e.g., to the access rights “R”=read, “U”=update, “W”=write, “D”=delete. Another symbol—here, “N”—may be used for a dissolving or deleting existing access rights.

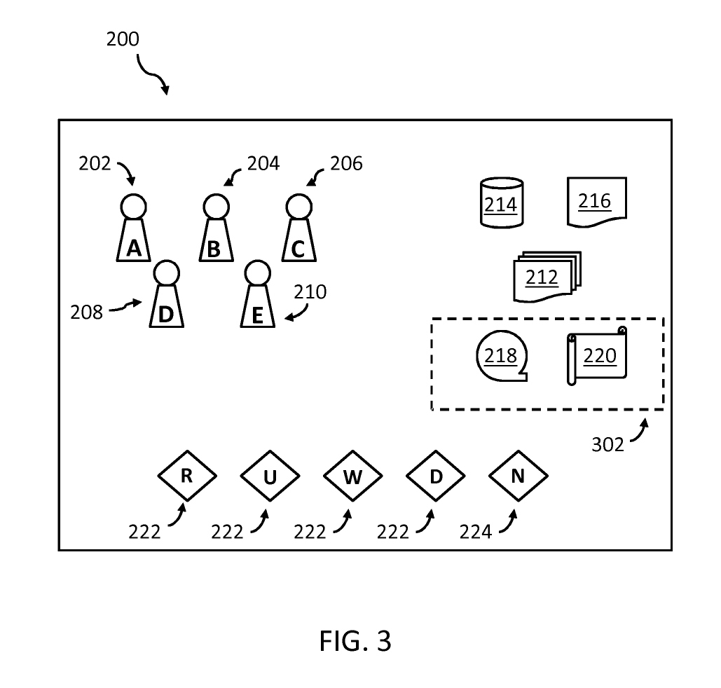

FIG. 3 shows an example for a selection of objects in the graphical user interface. In this example, the objects 218 and 220 are encircled and thus, high-lighted. A high-lighting may be possible in any other manner, e.g., be color background, blinking, changing of color, encircling, changing size and thickness of lines and so on. The selection may be applied to an object symbol, or a group of object symbols. The selection may be performed by the above described techniques. Additionally, a selection may be possible using a keyboard combination or by spanning a rectangular, encircling the symbols to be selected by using a mouse pointer.

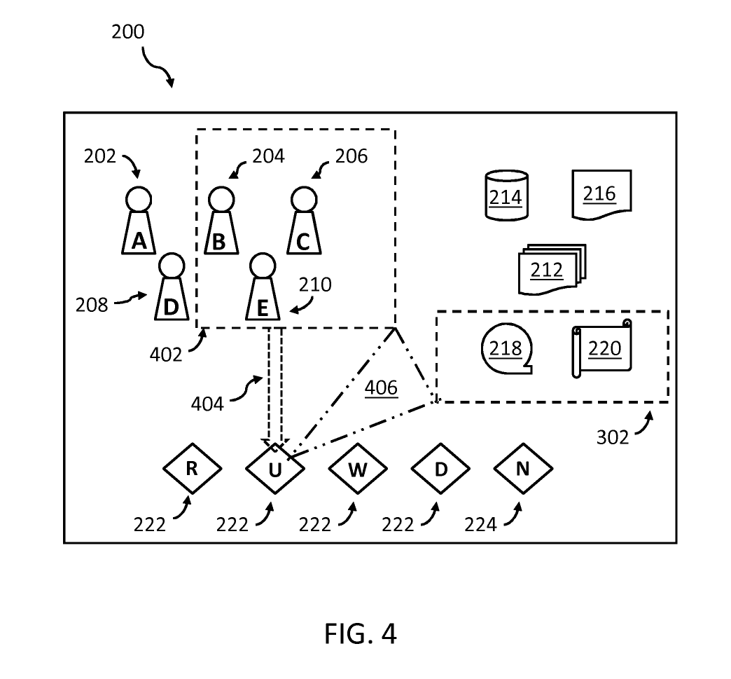

FIG. 4 shows an example for an assignment of several user symbols, access rights and objects (symbols). In addition to the diagram in FIG. 3, in FIG. 4 also user symbols 204, 206, 210 are selected. Also these are graphically enhanced in the same way as the object symbols or in alternative manner for making them recognizable as selected group. A movement of the selected group of users using the graphical user interface—e.g., by “click-hold-drag”—in direction of an access rights symbol 222—here, “U”—leads to an access rights assignment. With this, the users represented by the user symbols 204, 206, 210 are assigned access rights of the class “change” to the object 218 and 220. Assignments of other right may be performed in an analogue manner. The same applies for gesture and voice control.

Optionally, the user symbols may be selected and marked first, and afterwards the object symbols may be selected and dragged to the access rights symbol or symbols. Alternatively, the access rights symbols may be selected and marked first, then user symbols and at the end the access rights may be dragged onto the object symbols or user symbols. Each permutation is possible. Multi selection and high-lighting of symbols are always possible. In fact, the sequence of work steps or selection respectively, may be predefined guiding user or administrators, respectively; however, technically any sequence of selecting of symbols, high-lighting of the symbols and dragging of the symbols is possible. At the end of such a cycle, an assignment of one or more access rights to one or more objects by one or more user may be done. These dependencies may be filed or stored, respectively in the data storage.

Moreover, FIG. 4 shows that a user-object-access-rights combination may be displayed linked-up, e.g., by the lines 406. This way, the administrator may understand at first glance which users, objects and rights may be linked. This triangle may be dissolvable by clicking and dragging it to the access right “N”. For this, it may be sufficient, if one of the triangle corners may be moved to the “N” symbol. Moreover, the access rights symbols 222 may be grouped automatically, to high-light linked groups of access rights together. Such a method may also be useable for object symbols and user symbols.

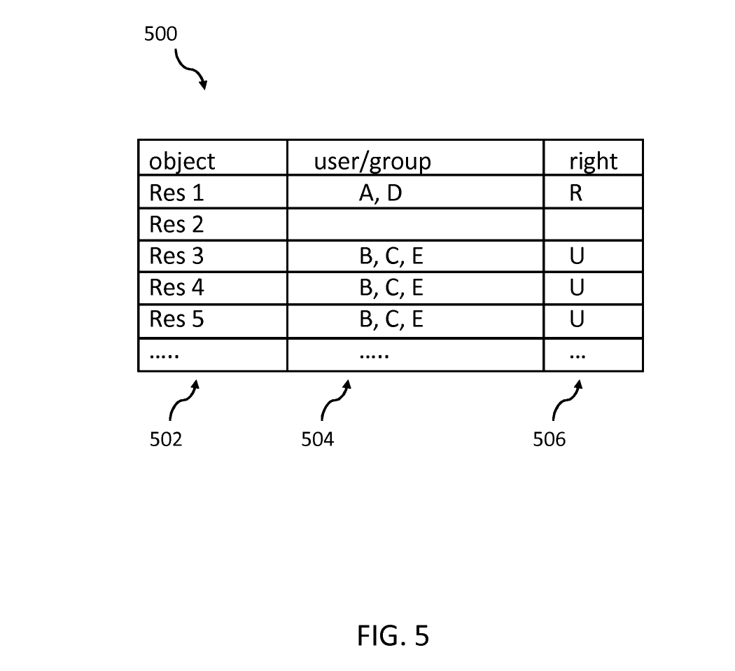

FIG. 5 shows, e.g., a table 500 for access rights management. Column 502 comprises object identifiers for resources—here, “Res 1”, “Res 2”, “Res 3”. Column 506 comprises access rights identifiers—here, “R” and “U” in column 504 user identifiers may be stored—here, “A”, “B”, “C”, “D”, “E”. The users with the user identifiers “A” and “C” may, for example, be granted the access right “R”—for, e.g., “read” to the objects “Res 1”. The object “Res 2” may not be accessed by any user because there is no entry in the table.

The users having the user identifications “B”, “C” and “E” have access rights of the class “update” to the objects “Res 3”, “Res 4”, “Res 5”. This complies also to the example in FIG. 4.

Other display and storage forms are possible; e.g., in a vendors specific access control list (ACL) or, in XACML or, in another markup language.

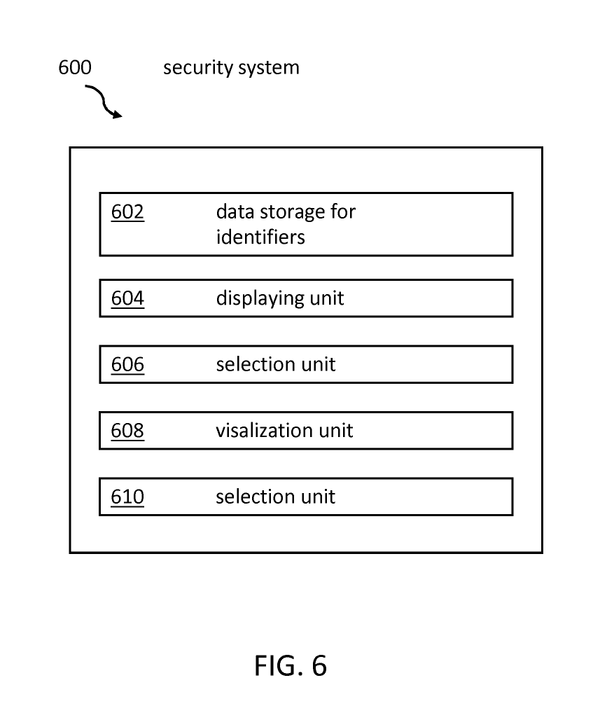

FIG. 6 shows a block diagram of a security system in a computer network. The security system comprises the following: a storage unit adapted for storing access rights identifiers, objects identifiers, and user identifiers in a data storage, a display unit 604 adapted for displaying of at least an object symbol, an access rights symbol and a user symbol in a graphical user interface of a computer, wherein the object symbol refers to an object identifier stored in the data storage, wherein the access rights symbol refers to an access rights identifier stored in the data storage, and wherein the user symbol refers to a user identifier stored in the data storage. Moreover, the security system comprises a selection unit 606, adapted for selecting of at least one object symbol relating to an object using the graphical user interface, and a visualization unit 608 adapted for visualizing of the selection of the object symbol, and a selection unit 610 adapted for selecting the user symbol using the graphical user interface and moving the user symbol in an environment of the access rights symbol, wherein in the data storage an access right is registered, the access rights being represented by the access rights symbol to the object, represented by the object symbol, for a user, represented by the user symbol, such that a security setting for the object is set in the computer network.

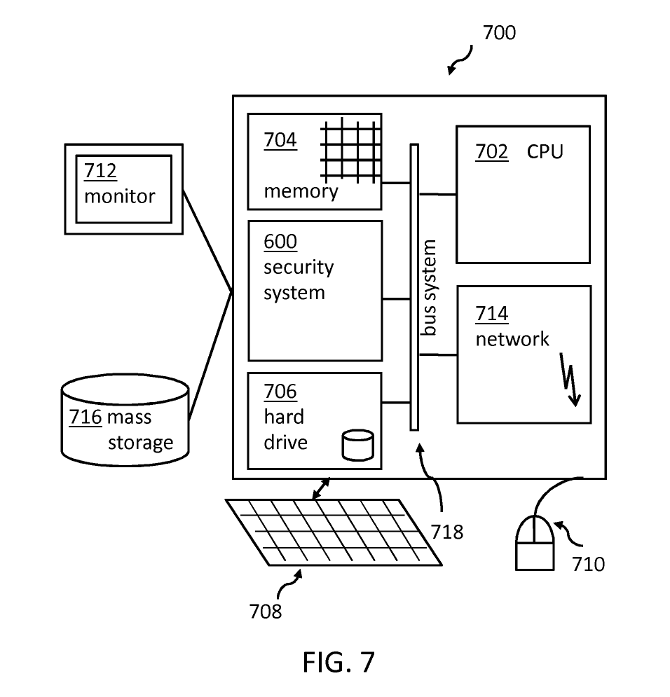

Embodiments of the invention may practically be performed by any computer type independent from the kind of storing and executing program code. As exemplarily shown in FIG. 7, the computer system 700 may comprise one or more processor(s) 702 each having one or more cores per processor, related storage elements 704, an internal storage device 706 (e.g., a hard drive, an optical drive like a CD drive or a DVD drive, a flash memory and so on) and a plurality of other elements and functional units typical for today's computers. The memory elements 704 may comprise a main memory—e.g., a random access memory—used during an actual execution of program code. Moreover, a cache memory may be available, which may be instrumental as temporal storage for at least a portion of the program code and/or data. This may help reducing the number of accesses to a permanent storage medium or an external long term storage 716. Elements within the computer system 700 may be linked by a bus system 718 with related adapters. Additionally, a security system 600 may be linked to the bus system 718.

The computer system 700 may also include input means, such as a keyboard 708, a pointing device like a computer mouse 710, or a microphone/loudspeaker combination (not shown). Furthermore, the computer 700, may include output means, such as a monitor 712 [e.g., a liquid crystal display (LCD), a plasma display, a light emitting diode display (LED), or cathode ray tube (CRT) monitor]. The computer system 700 may be connected to a network (e.g., a local area network (LAN), a wide area network (WAN), such as the Internet or any other similar type of network, including wireless networks via a network interface connection 714. This may allow a coupling to other computer systems or a storage network or a tape drive. Those, skilled in the art will appreciate that many different types of computer systems exist, and the aforementioned input and output means may take other forms. Generally speaking, the computer system 700 may include at least the minimal processing, input and/or output means, necessary to practice embodiments of the invention.

Further, those skilled in the art will appreciate that one or more elements of the afore-mentioned computer system 700 may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources, or a smartphone.

Further, software instructions to perform embodiments of the invention may be stored on a computer readable medium, such as a compact disk (CD), a diskette, a tape, or any other computer readable storage device.

In summary we may state:

The method allows an elegant, graphically supported multi-setting of access rights for users to objects in a computer network. Using a graphical user interface, symbols are moved. This kind of assignment leads to a linking in form of a user-object-access-rights combination permanently storable in a data storage. Manually performed list entries in access rights lists may no longer be required. This may save a lot of effort of a system administrator. Moreover, a not so skilled systems administrator may handle the system more intuitively.

1. Method (100) for a setting of security settings in relation to objects in a computer network, wherein the method (100) comprises:
storing (102) of access rights identifiers, object identifiers and user identifiers in a data storage,
displaying (104) of at least one object symbol (212, 214, 216, 218, 220), an access rights symbol (222) and a user symbol (202, 204, 206, 208, 210) in a graphical user (200) of a computer (700), wherein the object symbol (212, 214, 216, 218, 220) relates to the object identifier stored in the data storage, wherein the access rights symbol (222) relates to the access rights identifier stored in the data storage, and wherein the user symbol (202, 204, 206, 208, 210) relates to the user identifier stored in the data storage,
selecting (106) at least one object symbol (212, 214, 216, 218, 220) relating to one of the objects using the graphical user interface (200),
visualizing (108) the selection of the object symbol (212, 214, 216, 218, 220),
selecting (110) the user symbol (202, 204, 206, 208, 210) using the graphical user interface, and moving (114) the user symbol (202, 204, 206, 208, 210) in an environment of the access rights symbol (222), wherein in the data storage an access right, defined by the access rights symbol (222), to the object, defined by the object symbol (212, 214, 216, 218, 220), for a user identifier, defined by the user symbol (202, 204, 206, 208, 210), is registered, such that a security setting to the object in the computer network is set.

2. The method (100) according to claim 1, wherein at least one of the object symbols (212, 214, 216, 218, 220) in the user interface (200), access rights symbols (222) and user symbols (202, 204, 206, 208, 210) comprise a label (224, 226), stored in the data storage.

3. The method according to claim 1 or 2, wherein the graphical user interface (200) is operated using a pointing device or using a touch sensitive display.

4. The method (100) according to any of the previous claims, wherein the selecting (206, 110) in the graphical user interface (200) is performed using gesture or voice recognition.

5. The method (100) according to any of the previous claims, wherein the data storage is a table (500) in a file system of a computer (700).

6. The method (100) according to any of the previous claims, wherein, the method (100) comprises:
selecting an object-access-rights-user combination (406) and dissolving the same by a delete symbol (224) in the graphical user interface (200).

7. The method (100) according to any of the previous claims, wherein one of the access rights comprises an access limitation within a time period, or to a process step in a workflow, or to a project status, or to an access location, where the user is located.

8. Security system (600) for a setting of security settings in a computer network, the security system comprising:
a storage unit (602) adapted for storing of access rights to objects for a user in a storage unit,
a displaying unit (604) adapted to display (104) of at least an object symbol (212, 214, 216, 218, 220), an access rights symbol (222) and a user symbol (202, 204, 206, 208, 210) in a graphical user interface (200) of a computer, wherein the object symbol (212, 214, 216, 218, 220) relates to an object identifier stored in the data storage, wherein an access rights symbol (222) relates to an access rights identifier stored in the data storage, and wherein the user symbol (202, 204, 206, 208, 210) relates to a user identifier stored on the data storage,
a selection unit (606) adapted for selecting of at least an object symbol (212, 214, 216, 218, 220) relating to the object using the graphical user interface (200),
a visualization unit (608) adapted for visualizing the selection of the object symbol (212, 214, 216, 218, 220),
a selection unit (610) adapted for selection the user symbol (202, 204, 206, 208, 210) using the graphical user interface (200) and moving the user symbol (202, 204, 206, 208, 210) in an environment of the access rights symbol (222), wherein in the data storage an access right, defined by the access rights symbol (222), to the object, defined by the object symbol (212, 214, 216, 218, 220) for a user, defined by the user symbol (202, 204, 206, 208, 210) is registered such that a security setting to the object in the computer network is set.

9. Computer system (700) comprising the security system according to claim 8.

10. Data processing program product for a setting of security settings to be performed in a data processing system comprising software code portions adapted to execute the method according to any of the claims 1 to 7 if the computer program is executed on a data processing system (700).

11. Computer program product for a setting of security settings, stored on a computer-readable medium, wherein the Computer program product comprises computer-executable program portions adapted to cause the computer to execute the method according to any of the claims 1 to 7 if the program portions are executed on the computer (700).
